(19) United States
(12) Patent Application Publication
(10) Pub. No.: US 2017/0208779 A1
(43) Pub. Date: Jul. 27, 2017

(54) Beehive Assembly

(71) Applicant: Todd Rubright, Fallbrook, CA (US)

(72) Inventor: Todd Rubright, Fallbrook, CA (US)

(21) Appl. No.: 15/005,692

(22) Filed: Jan. 25, 2016

(51) Int. Cl. A01K 51/00; A01K 47/06; A01K 47/02

(52) U.S. Cl. CPC A01K 51/00; A01K 47/02; A01K 47/06

(57) ABSTRACT

A beehive assembly that includes first, second and third stacked box-like hive sections that are securely interconnected by specially designed corner brackets. An important feature of the beehive assembly resides in the provision of a novel temperature control apparatus that is connected to the first box-like hive section for controlling the temperature of the interior chambers of the bee hive assembly. The temperature control apparatus here comprises a thermoelectric plate, an electrical power source operably associated with the thermoelectric plate and a plurality of fans for circulating the heated air within the hive.

### CROSS-REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

Field of the Invention

The present invention relates generally to beehive assemblies of the type having a plurality of stackable box-like hive elements adapted to receive comb frames. More particularly, the invention concerns a novel beehive assembly of the aforementioned character that includes a novel temperature control unit for controlling the temperature within the box-like hive elements.

Background of the Invention

For several decades beehives of the character used for general bee keeping operations have remained substantially unchanged. The typical prior art beehive is made up of a number of stacked, box-like hive sections that are open at the top and bottom. The hive sections are designed to removably support a plurality of honeycomb frames onto which bees draw out a wax “honeycomb”, which is used by the bees to store pollen and honey. The lowermost hive section is supported on a stand and is provided with an opening through which the bees enter. The uppermost hive section is typically covered by a top lid.

A long-standing problem in prior art beekeeping operations has been the inability to properly control the temperature of the hive sections. While a number of attempts have been made in the past to properly control the temperature of the hive sections, for the most part, reliance has been placed on the bees themselves to maintain optimum temperature conditions within the hive.

One early attempt at maintaining optimum temperature conditions within the beehive is described in U.S. Pat. No. 2,530,801 issued to H. Babcock, JR. This patent describes a somewhat elaborate ventilated, insulated cover for the beehive. The Babcock cover is constructed from a non-sagging, rigid insulation board having ventilating channels that is enclosed between two metal sheets. The inner metal sheet is perforated so that the warm moist air rising from the bodies of bees may pass there through. The rigid insulation board and the enclosing metal sheets are mounted on an open frame having ventilating openings in the bottom of the frame to provide all weather outlets.

U.S. Pat. No. 6,579,147 issued to DeYoung describes a somewhat similar temperature control approach to that taken by Babcock. More particularly, the De Young invention concerns a vented beehive cover for keeping a beehive cooler in hot climates in order to increase honey production. The beehive cover includes a bottom board which has a lower hive body stacked there atop. An upper hive body is stacked atop the lower hive body, and a venting cover encloses the upper hive body. The venting cover shifts with respect to the upper hive body in order to utilize wind direction and maximize cooling of the beehive.

U.S. Pat. No. 4,300,250 issued to Taylor describes a somewhat different approach to beehive temperature control. More particularly, the Taylor invention concerns beehives that exhibit the venting of moisture, wind protected entrances, closable bottom boards of sufficient depth to encourage breeding, and other attributes that minimize wintertime losses attributable to starvation dysentery and other causes.

### SUMMARY OF THE INVENTION

By way of brief summary, the present invention concerns a novel beehive assembly that includes first, second and third stacked box-like hive sections that are securely interconnected by specially designed corner brackets. Each of the box-like hive sections comprises four interconnected sides that are sturdily constructed from tongue and groove siding. The sides of the first hive section cooperate to define a first interior chamber, the sides of the second hive section cooperate to define a second interior chamber and the sides of the third hive section cooperate to define a third interior chamber. An important feature of the beehive assembly of the invention resides in the provision of a novel temperature control apparatus that is connected to the first box-like hive section for controlling the temperature of the first and second interior chambers of the bee hive assembly. In the preferred form of the invention, the temperature control apparatus comprises a thermoelectric plate and an electrical power source operably associated with the thermoelectric plate.

With the forgoing in mind, it is an object of the present invention to provide a novel beehive assembly that is of a sturdy, sanitizeable construction that includes a compact, highly efficient temperature control apparatus for controllably heating the interior of the beehive during cold weather.

Another object of the invention is to provide a beehive assembly of the type described in the preceding paragraph in which the temperature control apparatus includes a strategically located fan that provides efficient circulation of air throughout the interior chambers of the hive sections.

Another object of the invention is to provide a beehive assembly as described in the preceding paragraphs in which the temperature control apparatus includes fans that are strategically located inside and outside of the hive and function to controllably circulate air through the hive.

Another object of the invention is to provide a beehive assembly of the aforementioned character in which the first, second and third box-like hive sections are securely interconnected by hand-operated mechanical latches.

Another object of the invention is to provide a beehive assembly as described in the preceding paragraphs which is stable in transport and one that can be easily moved about on-site.

Another object of the invention is to provide a beehive assembly of the character described which is constructed in a manner to avoid invasion by pests such as raccoons, skunks and like animals.

Another object of the invention is to provide a beehive assembly as described in the preceding paragraphs in which the sidewalls of the beehive sections are constructed from insulating material.

Another object of the invention is to provide a beehive assembly of the aforementioned character that includes an adjustable base of novel construction for supporting the assembly in locations exhibiting uneven terrain.

The foregoing as well as other objects of the invention will be realized by the beehive assembly construction illustrated in the drawings and described in the paragraphs that follow.

### BRIEF DESCRIPTION OF THE DRAWINGS

FIG. 1 is a generally perspective view of one form of the beehive assembly of the present invention.

FIG. 1A is an enlarged, cross-sectional view taken along lines 1A-1A of FIG. 1.

FIG. 2 is an exploded, front view of the beehive assembly shown in FIG. 1.

FIG. 2A is an enlarged view taken along lines 2A-2A of FIG. 2.

FIG. 2B is an enlarged view taken along lines 2B-2B of FIG. 2.

FIG. 2C is an enlarged view taken along lines 2C-2C of FIG. 2.

FIG. 3 is an enlarged view of the area designated as 3-3 in FIG. 2A.

FIG. 4 is an enlarged, generally perspective view, partly broken away to show internal construction, of the lowermost box-like hive section shown in FIGS. 1 and 2A.

FIG. 5 is an enlarged view taken along lines 5-5 of FIG. 4.

FIG. 6 is a generally schematic view illustrating the manner of interconnection of the various components of the temperature control apparatus.

FIG. 7 is a generally perspective, exploded view illustrating one form of an adjustable hive support of the invention.

### DETAILED DESCRIPTION OF THE INVENTION

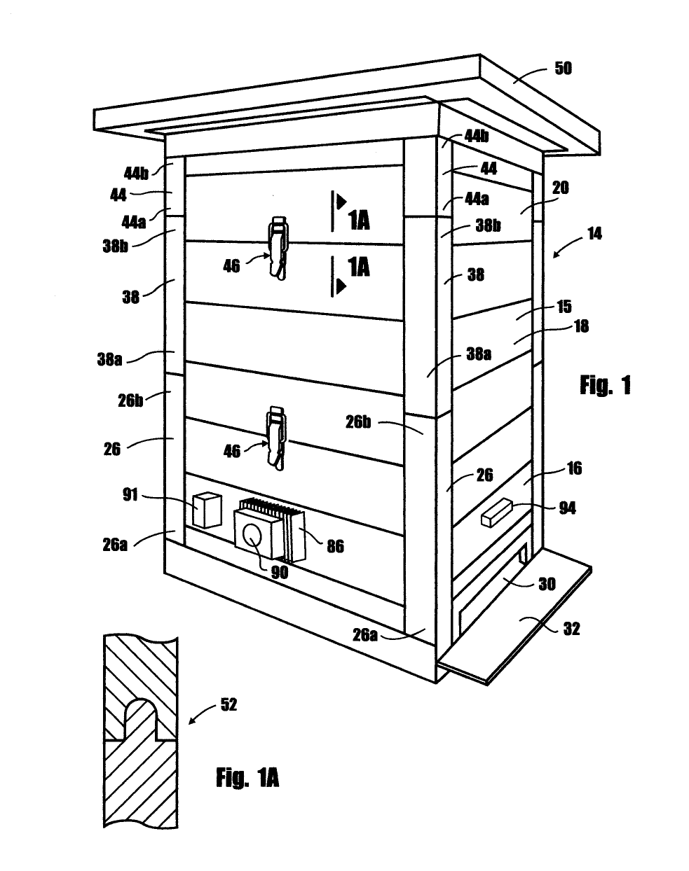

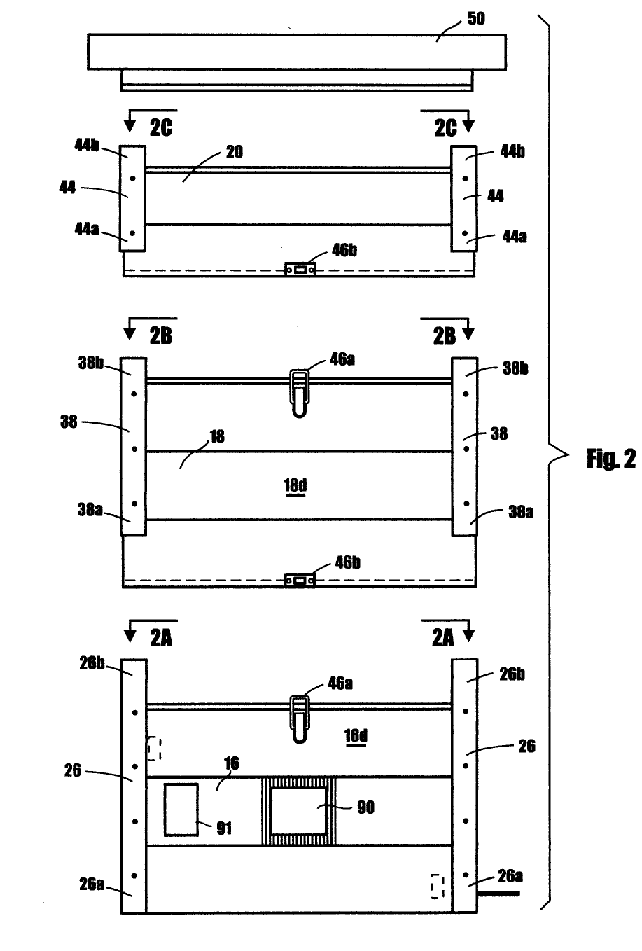

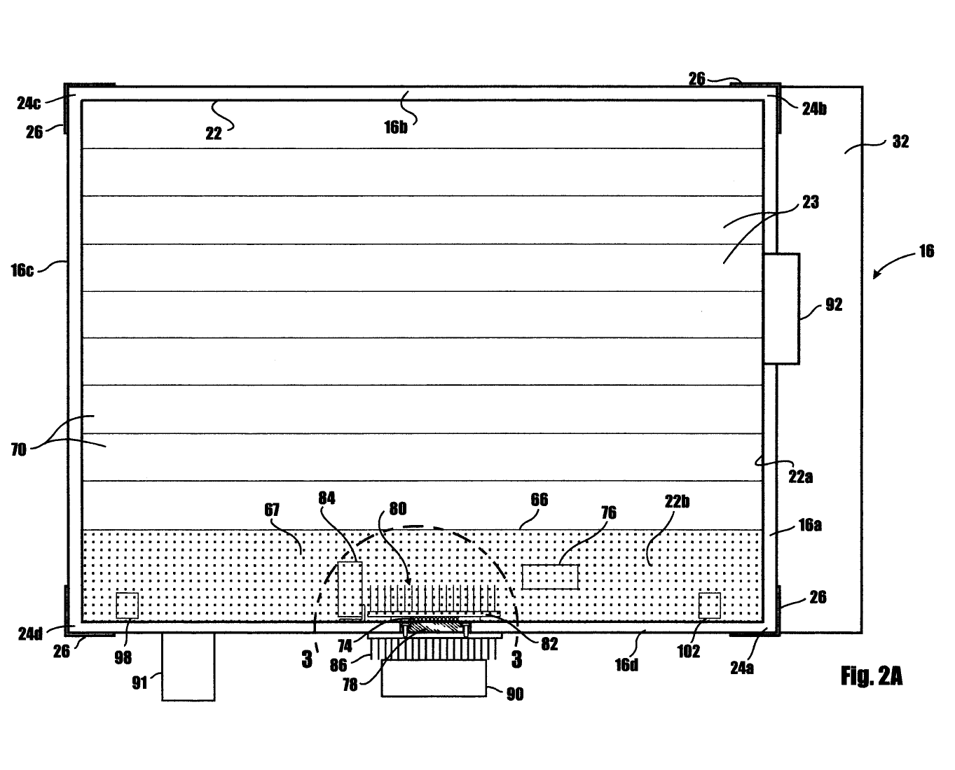

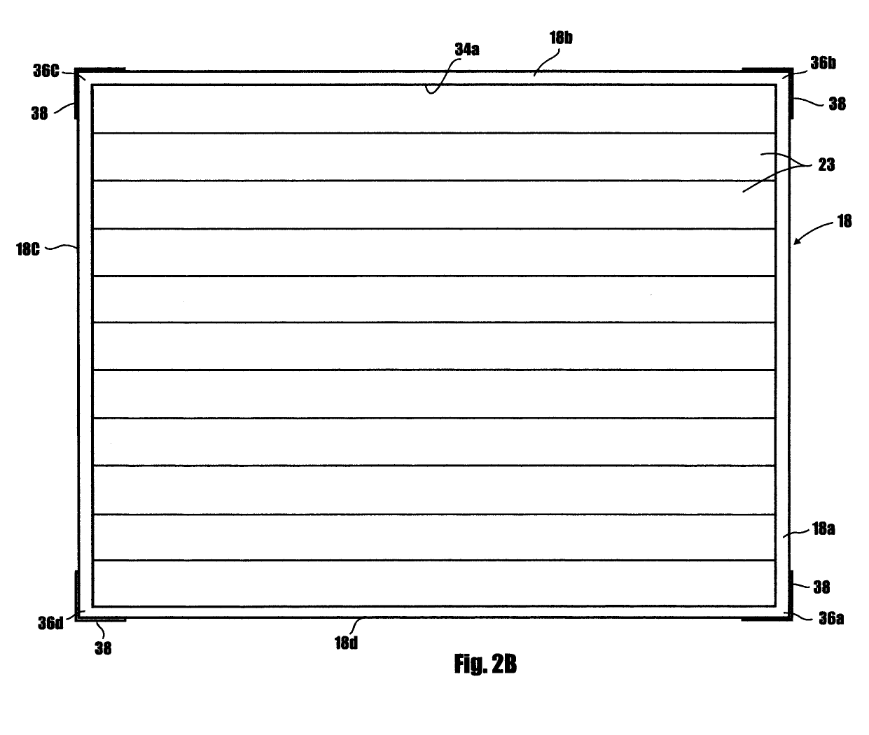

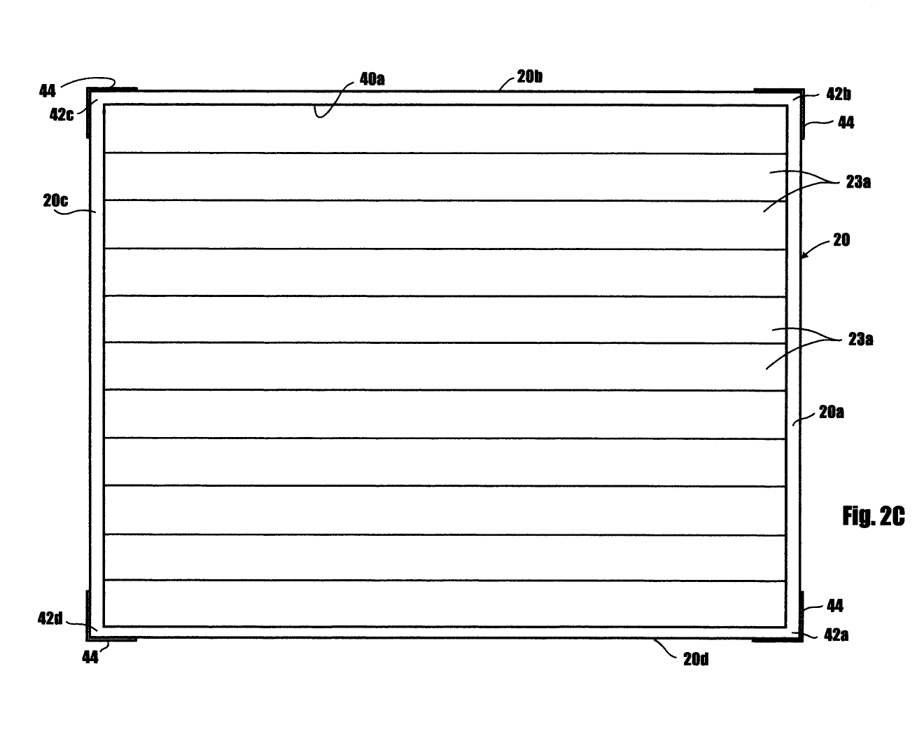

Referring to the drawings and particularly to FIGS. 1 and 2, one form of the beehive assembly is there shown and generally designated by the numeral 14. The beehive assembly 14 here comprises a housing 15 made up of first, second and third stacked box-like hive sections 16, 18 and 20. As illustrated in FIG. 2A, first box-like hive section 16 is made up of four interconnected sides 16a, 16b, 16c and 16d that cooperate to define a first interior chamber 22. As will be discussed in greater detail hereinafter, a portion of first interior chamber 22 functions to removably receive a plurality of brooding boards, or frames 23 of conventional design.

First box-like hive section 16 has four corners 24a, 24b, 24c and 24d and importantly includes four identical, elongate metal corner braces 26 that are connected to the four corners in the manner shown in FIG. 2A. As indicated in FIGS. 1 and 2 of the drawings, each of the elongate corner braces has a lower portion 26a and an upper portion 26b. First box-like hive section 16 is also provided with a bee entrance 30 and an entrance platform 32.

Second box-like hive section 18, which is connected to first box-like hive section 16, comprises four interconnected sides 18a, 18b, 18c and 18d that cooperate to define a second interior chamber 34a. As indicated in FIG. 2B of the drawings, interior chamber 34a functions to also removably receive a plurality of brooding boards 23 of conventional design. Second box-like hive section 18 has four corners 36a, 36b, 36c and 36d and importantly includes four identical, elongate metal corner braces 38 that are connected to the four corners in the manner shown in FIG. 2B. As indicated in FIGS. 1 and 2 of the drawings, each of the elongate corner braces has a lower portion 38a and an upper portion 38b.

Third box-like hive section 20, which is connected to second box-like hive section 18, comprises four interconnected sides 20a, 20b, 20c and 20d that cooperate to define a third interior chamber 40a. Third box-like hive section 20 functions as a conventional “super” where the honey is stored in frames or boards 23a of conventional design. Third box-like hive section 20 has four corners 42a, 42b, 42c and 42d and importantly includes four identical, elongate metal corner braces 44 that are connected to the four corners in the manner shown in FIG. 2C. As indicated in FIGS. 1 and 2 of the drawings, each of the elongate corner braces has a lower portion 44a and an upper portion 44b.

As indicated in the drawings, when the first and second box-like hive sections 16 and 18 are interconnected in the stacked relationship shown in FIG. 1, the upper portions 26b of the corner braces 26 of the first hive section overlap the lower portion of the second hive section and butt up against the lower portions 38a of the corner braces 38 of the second hive section thereby providing a rigid connection between the hive sections. With the second hive section in position, the loop portion 46a of the latching mechanism 46, which is connected to the first hive section, can be interconnected with the loop connector portion 46b of the latching mechanism which is connected to the second hive section thereby releasably interlocking together the first and second hive sections.

When the second and third box-like hive sections 18 and 20 are interconnected in the stacked relationship shown in FIG. 1, the upper portions 38b of the corner braces 38 of the second hive section overlap the lower portion of the third hive section and butt up against the lower portions 44a of the corner braces 44 of the third hive section thereby providing a rigid connection between the hive sections. With the third hive section in position, the loop portion 46a of the latching mechanism 46, which is connected to the second hive section, can be interconnected with the loop connector portion 46b of the latching mechanism which is connected to the third hive section thereby releasably interlocking together the second and third hive sections.

As illustrated in FIG. 1 of the drawings, a top wall or lid section 50 rests upon the upper portion of the third hive section and functions to close interior chamber 40a of the third hive section 20.

Latch mechanism 46 can be of various readily available constructions, but a draw latch mechanism of the character offered for sale by the Southco Company of Concordville, Pa. has proven satisfactory for use in the apparatus of the present invention.

In order to provide further strength and stability to the beehive assembly of the invention, each of the sidewalls of the first, second and third hive sections is constructed from tongue and groove siding having the tongue and groove configuration 52 illustrated in FIG. 1A of the drawings.

As will be discussed in greater detail in the paragraphs that follow, an important feature of the present invention is the provision of a novel temperature control apparatus for controlling the temperature within the first, second and third hive sections. Contributing to the control of the temperature of the hive sections is the fact that each of the sidewalls of the first, second and third hive sections is constructed from a readily commercially available insulating material.

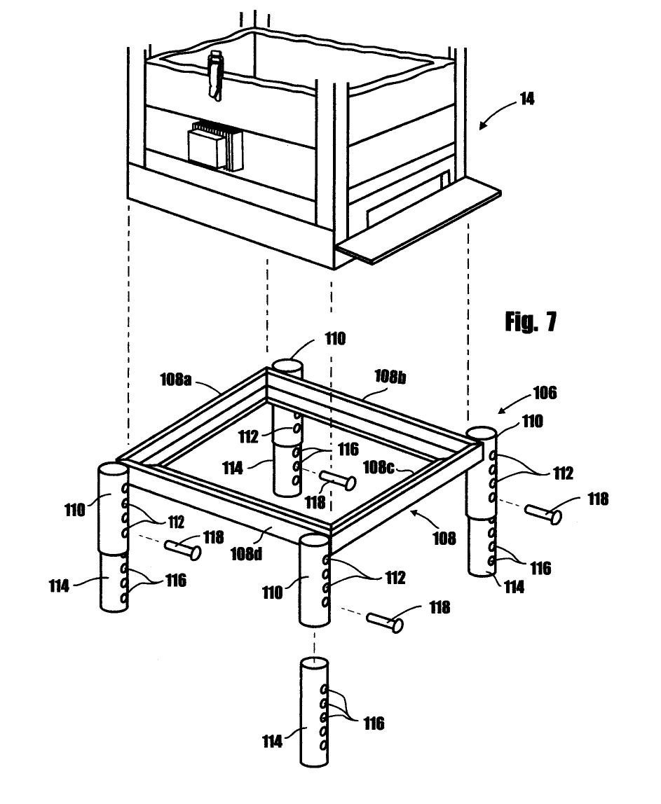

Because of the rigid construction of the beehive assembly of the invention as described in the preceding paragraphs, the assembly can be easily moved from location to location and can be supported on a variety of fixed and adjustable bases such as benches, brick and concrete foundations and, if necessary, on the ground. As will be discussed in greater detail hereinafter, to enable the assembly of the invention to be used in locations where the ground is uneven, a readily adjustable support mechanism of the character illustrated in FIG. 7 of the drawings is provided.

Referring particularly to FIG. 2A of the drawings, it is to be noted that the first box-like hive section 16 includes a porous partition wall 66 that is mounted within the first interior chamber 22 of the first box-like hive section. Partition wall 66 divides the first interior chamber into first and second sub-chambers 22a and 22b. As indicated in the drawings, sub-chamber 22b is screened off from sub-chamber 22a by a mesh screen 67 that isolates the sub-chamber from working bees operating within the hive. As previously discussed, first sub-chamber 22a functions to removably receive a plurality of brooding boards or frames 23 of conventional design while, as will be discussed in greater detail in the paragraphs which follow, second sub-chamber 22b functions to house certain critical components of the important temperature control apparatus of the invention for controlling the temperature of the first, second and third interior chambers of the assembly.

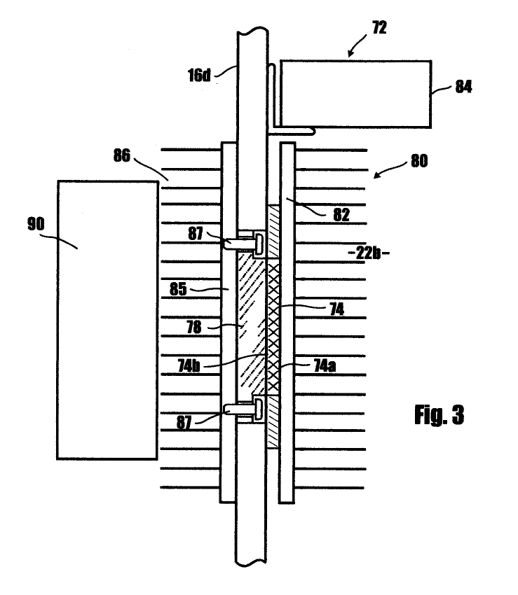

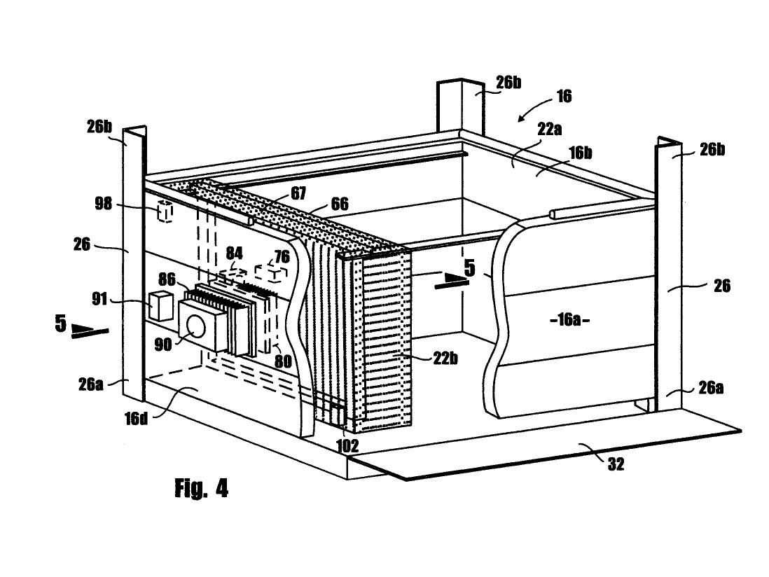

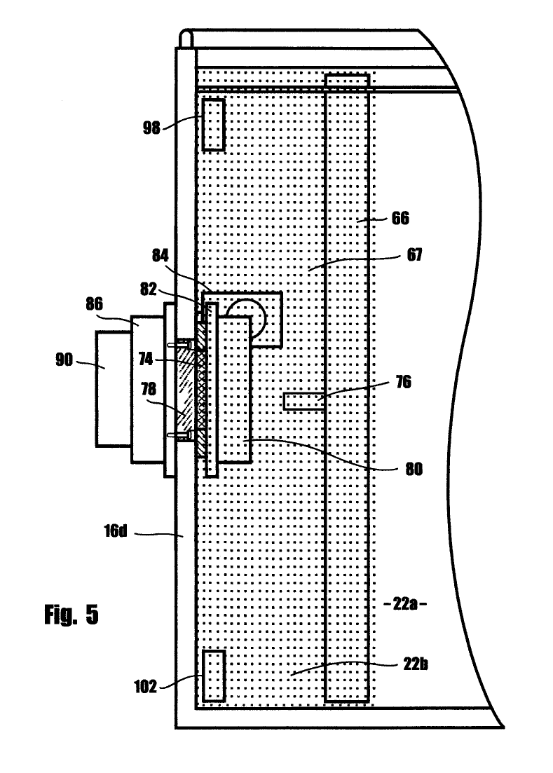

Turning particularly to FIGS. 3, 4 and 6, the important temperature control apparatus of the invention, which is generally designated in the drawings by the numeral 72, can be seen here to comprise a thermoelectric plate 74 and an electrical power source 76, both of which are mounted within interior chamber 22b of first box-like hive section 16. Electrical power source 76 can take various forms well known to those skilled in the art, including solar power panels.

Thermoelectric plate 74 is here provided in the form of what is commonly known as a Peltier plate. Thermoelectric plates, such as plate 74, create a heat flux between the junction of two different types of materials and can be used to heat and cool various types of apparatus and enclosures. Advantageously, thermoelectric plates have no moving internal parts, are quite compact, are quiet in operation and have a relatively long useful life. While thermoelectric plates, such as plate 74, are available from a number of sources, a plate suitable for use in the apparatus of the present invention is readily available from Watronix, Inc of West Hills, Calif.

Thermoelectric plate 74 has a first or hot surface 74a that emits heat and a second or cold surface 74b that absorbs heat (FIG. 3). Heat emitted from the hot surface includes at least some of the heat absorbed from the cold surface. Accordingly, dissipating heat from the hot surface facilitates heat absorption by the cold surface.

Mounted within the front wall 16d of box-like hive section 16 and in thermally conductive communication with the second surface 74b of thermoelectric plate 74 is a thermal transfer block 78. Thermal transfer block 78 is here provided in the form of an aluminum block that is in thermally conductive engagement with both the interior and exterior sides of front wall 16d. The first surface 74a of the thermoelectric plate 74 is in thermally conductive communication with an interior aluminum heatsink 80 via a spacer 82, both of which are mounted within sub-chamber 22b. Also mounted within sub-chamber 22b, proximate heatsink 80 is a conventional, commercially available distribution fan 84 that is adapted to draw heated air from the heatsink and circulate it throughout the interior of the hive. In the present form of the invention, thermal transfer block 78 is in thermally conductive communication via a spacer 85 with an exterior aluminum heatsink 86. As depicted in FIG. 3 of the drawings, spacer 85 is connected to the heat transfer block 78 by threaded connectors 87. Mounted on, or adjacent to exterior heatsink 86, is a conventional temperature balance fan 90 that is adapted to dissipate thermal energy (heat) that is removed from sub-chamber 22b by the plate 74. Mounted on the front wall 16d proximate the temperature balance fan 90 is electrical connection box 91 that houses certain of the electrical components of the apparatus. As indicated in the drawings, in the preferred form of the apparatus of the invention a high temperature exhaust fan 92 is mounted within wall 16a of first hive section 16 for exhausting overheated air from the hive. Fans 84, 90 and 94 are commercially available from numerous sources including a branch of Grainger Industrial Supply located in Burbank, Calif.

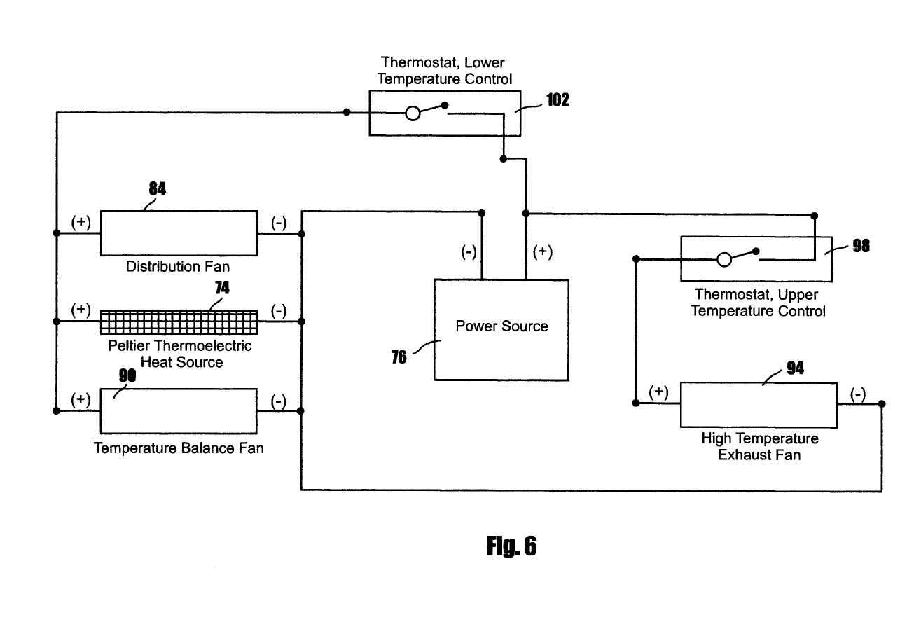

Also forming a part of the temperature control apparatus of the invention are upper and lower temperature limit thermostats 98 and 102 that are mounted within sub-chamber 22a. Upper temperature limit thermostat 98 functions to control the operation of the high temperature exhaust fan 94, while lower temperature limit thermostat 102 controls the amount of DC voltage delivered to the thermoelectric plate 74 and to the distribution and temperature balance fans 84 and 90. The thermoelectric plate, the thermostats and the fans are in electrical communication with each other in a conventional manner illustrated in FIG. 6 of the drawings.

As shown in FIG. 3, the cold side of the thermoelectric plate 74 is thermally coupled to the thermal transfer block 78. In operation, heat is absorbed by the cold side of the thermoelectric plate 74 which causes the temperature of the associated thermal transfer block 78 to decrease. As the thermal transfer block temperature decreases, heat is absorbed into the thermal transfer block and thermally conducted into the thermoelectric plate 74. Heat energy from the hot side of the thermoelectric plate 74 is subsequently conducted into the first interior chamber 22 via heatsink 80. The heated air is then circulated through the hive by fan 84 which is controlled by lower temperature thermostat 98.

Upper temperature control thermostat 102, which is operably associated with fan 96, functions to controllably actuate the high temperature exhaust fan 96 in a manner to exhaust over heated air from the hive via exhaust port 94.

Referring now to FIG. 7 of the drawings, when the beehive of the invention is to be positioned in an area of uneven ground, the novel adjustable base frame 106 can be effectively used. Base frame 106 here comprises a hive support frame 108 made up of four interconnected lengths of right angle iron 108a, 108b, 108c and 108d. Connected to each corner of the hive support frame 108 is a tubular member 110 having a plurality of vertically spaced apart apertures 112. Telescopically receivable within each of the tubular members 110 is a vertically adjustable leg 114. Each leg 114 is provided with a plurality of vertically spaced apart apertures 116 that can be aligned with the apertures 112 provided in the tubular members 110 as the leg is telescopically moved upwardly and downwardly. To lock each leg in a selected position within its mating tubular member 110 is a locking pin 118 that is telescopically receivable within mating apertures 112 and 116. With this construction, each of the legs 114 can be vertically positioned within its mating tubular member 110 and locked in its selected position with a locking pin so as to orient the supporting frame 108 in a substantially horizontal plane.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention as set forth in the following claims.

I claim:

1. Beehive assembly comprising a housing including:
(a) a first box-like hive section comprising four interconnected sides cooperating to define a first interior chamber;
(b) a second box-like hive section connected to said first box-like hive section, said second box-like hive section comprising four interconnected sides cooperating to define a second interior chamber; and
(c) a temperature control apparatus carried by said housing for controlling the temperature of said first and second interior chambers of said beehive assembly, said temperature control apparatus comprising a thermoelectric plate and an electrical power source operably associated with said thermoelectric plate.

2. The beehive assembly as defined in claim 1 further including a latching mechanism for latching together said first and second box-like hive sections.

3. The beehive assembly as defined in claim 1 in which said first box-like hive section includes a bee access opening.

4. The beehive assembly as defined in claim 1 in which said first box-like hive section has four corners and includes an elongate corner brace connected to each of said four corners, each said elongate corner brace having an upper portion and a lower portion and in which said sidewalls of said second box-like hive section are connected to said upper portions of said elongate corner braces.

5. The beehive assembly as defined in claim 4 in which said first box-like hive section further includes a porous partition wall mounted within said first interior chamber of said first box-like hive section, said porous partition dividing said first interior chamber into first and second sub-chambers, said thermoelectric plate and said electrical power source being mounted within said first sub-chamber.

6. The beehive assembly as defined in claim 4 in which said thermoelectric plate has first and second surfaces and in which said temperature control apparatus further includes a first heatsink disposed in thermally conductive communication with said first surface of said thermoelectric plate.

7. The beehive assembly as defined in claim 6 in which said temperature control is apparatus further includes a first fan mounted within said first sub-chamber of said first box-like hive section proximate said first heatsink, said first fan being constructed and arranged to circulate air around and about said first heatsink.

8. The beehive assembly as defined in claim 7 further including a thermal transfer block disposed in thermally conductive communication with said second surface of said thermoelectric plate.

9. The beehive assembly as defined in claim 8 in which said temperature control apparatus further includes a second heatsink disposed in thermally conductive communication with said thermal transfer block.

10. The beehive assembly as defined in claim 9 in which said temperature control apparatus further includes a second fan connected to said first box-like hive section proximate said second heatsink, said second fan being constructed and arranged to circulate air around and about said second heatsink.

11. The beehive assembly as defined in claim 10 in which said temperature control apparatus further includes a thermostat mounted within said housing, said thermostat being operably associated with said thermoelectric plate.

12. A beehive assembly comprising a housing including:
(a) a first box-like hive section comprising four interconnected sides cooperating to define a first interior chamber;
(b) a second box-like hive section connected to said first box-like hive section, said second box-like hive section comprising four interconnected sides cooperating to define a second interior chamber; and
(c) a temperature control apparatus carried by said housing for controlling the temperature of said first and second interior chambers of said beehive assembly, said temperature control apparatus comprising:
(i) a thermoelectric plate mounted within said first interior chamber of said first box-like hive section, said thermoelectric plate having first and second surfaces;
(ii) an electrical power source mounted within said first interior chamber of said first box-like hive section and being operably associated with said thermoelectric plate;
(iii) a first heatsink mounted within said first interior chamber of said first box-like hive section, said first heatsink being disposed in thermally conductive communication with said first surface of said thermoelectric plate; and
(iv) a first fan mounted within said first interior chamber of said first box-like hive section proximate said first heatsink, said first fan being constructed and arranged to circulate air around and about said first heatsink.

13. The beehive assembly as defined in claim 12 in which said first box-like hive section has four corners and includes an elongate corner brace connected to each of said four corners, each said elongate corner brace having an upper portion and a lower portion and in which said four sidewalls of said second box-like hive section are connected to said upper portions of said elongate corner braces.

14. The beehive assembly as defined in claim 12 further including a hive support frame for supporting said first box-like hive section; a plurality of tubular members connected to said hive support frame; and a plurality of legs telescopically receivable within said plurality of tubular members.

15. The beehive assembly as defined in claim 12 in which said first box-like hive section further includes a porous partition wall mounted within said first interior chamber of said first box-like hive section, said porous partition dividing said first interior chamber into first and second sub-chambers, said thermoelectric plate and said electrical power source being mounted within said first sub-chamber.

16. The beehive assembly as defined in claim 12 in which said temperature control apparatus further includes a thermostat mounted within said housing, said thermostat being operably associated with said thermoelectric plate and with said first fan.

17. The beehive assembly as defined in claim 16 in which said temperature control apparatus further includes a second thermostat mounted within said housing.

18. A beehive assembly comprising a housing including:
(a) a first box-like hive section comprising four interconnected sides cooperating to define a first interior chamber, said first box-like hive section having four corners and including an elongate corner brace connected to each of said four corners, each said elongate corner brace having an upper portion and a lower portion;
(b) a second box-like hive section connected to said first box-like hive section, said second box-like hive section comprising four interconnected sides cooperating to define a second interior chamber, said second box-like hive section having four corners and including an elongate corner brace connected to each of said four corners, each said elongate corner brace having an upper portion and a lower portion;
(c) a third box-like hive section connected to said second box-like hive section, said third box-like hive section comprising four interconnected sides cooperating to define a third interior chamber, said sidewalls of said third box-like hive section being connected to said upper portions of said elongate corner braces of said second box-like hive section;
(d) a top wall connected to said third box-like hive section and covering said third interior chamber; and
(c) a temperature control apparatus connected to said housing for controlling the temperature of said first, second and third interior chambers of said beehive assembly, said temperature control apparatus comprising:
(i) a thermoelectric plate mounted within said first interior chamber of said first box-like hive section, said thermoelectric plate having first and second surfaces;
(ii) an electrical power source mounted within said first interior chamber of said first box-like hive section and being operably associated with said thermoelectric plate;
(iii) a first heatsink mounted within said first interior chamber of said first box-like hive section, said first heatsink being disposed in thermally conductive communication with said first surface of said thermoelectric plate;
(iv) a first fan mounted within said first interior chamber of said first box-like hive section proximate said first heatsink, said first fan being constructed and arranged to circulate air around and about said heatsink; and
(v) a first thermostat mounted within said housing, said first thermostat being operably associated with said thermoelectric plate and with said first fan.

19. The beehive assembly as defined in claim 18 further including a thermal transfer block disposed in disposed in thermally conductive communication with said second surface of said thermoelectric plate.

20. The beehive assembly as defined in claim 19 in which said temperature control apparatus further includes:
(a) a second heatsink disposed in engagement with said thermal transfer block;
(b) a second fan connected to said first box-like hive section proximate said second heatsink, said second fan being constructed and arranged to circulate air around and about said second heatsink;
(c) an exhaust fan mounted within said housing for exhausting air from said housing; and
(d) a second thermostat mounted within said housing, said thermostat being operably associated with said exhaust fan.
